(19) United States
(12) Patent Application Publication
(10) Pub. No.: US 2016/0044752 A1
(43) Pub. Date: Feb. 11, 2016

(54) LIGHT SOURCE APPARATUS AND LIGHT SOURCE DRIVING APPARATUS

(71) Applicant: SAMSUNG ELECTRONICS CO., LTD., Suwon-si (KR)

(72) Inventor: Sok Hyun JO, Incheon (KR)

(73) Assignee: SAMSUNG ELECTRONICS CO., LTD., Suwon-si (KR)

(21) Appl. No.: 14/697,796

(22) Filed: Apr. 28, 2015

(30) Foreign Application Priority Data
Aug. 5, 2014 (KR) 10-2014-0100601

(51) Int. Cl. H05B 33/08

(52) U.S. Cl. CPC H05B 33/083; H05B 33/0809; H05B 33/0854

(57) ABSTRACT

A light source apparatus includes a light source including a first to an n-th light source groups respectively including at least one light emitting diode (LED), a power path controller connected to first ends of the first to the n-th light source groups and configured to selectively provide a driving power to at least one of the first to the n-th light source groups, and a ground path controller connected to second ends of the first to the n-th light source groups and configured to control a path of a current flowing through the light source based on a level of the driving power. The first to the n-th light source groups are sequentially connected to one another, and the second end of the n-th light source group is connected to the first end of the first light source group.

### CROSS-REFERENCE TO RELATED APPLICATION

This application claims priority from Korean Patent Application No. 10-2014-0100601, filed on Aug. 5, 2014, with the Korean Intellectual Property Office, the disclosure of which is incorporated herein in its entirety by reference.

### BACKGROUND

1. Field

Apparatuses consistent with exemplary embodiments relate to a light source apparatus and a light source driving apparatus.

2. Description of the Related Art

Light emitting diodes (LEDs) have a relatively long lifespan, lower power consumption, improved initial operating characteristics, higher vibration resistance, and the like, as compared to filament-based light emitting devices, and thus, a demand for light emitting diodes is continuously increasing. Further, since light emitting diodes have characteristics such that light emitting diodes are driven by direct current (DC) power, light source apparatuses using light emitting diodes may employ constant current circuits. However, a constant current circuit may increase complexity of a device configuration, cause breakdowns in devices, or reduce lifespans of a light source apparatus.

### SUMMARY

One or more exemplary embodiments may provide a light source apparatus and a light source driving apparatus in which a circuit configuration may be relatively simplified and a lifespan may be extended.

According to an aspect of an exemplary embodiment, a light source apparatus includes a light source including a first to an n-th light source groups, n being an integer of two or more, and the first to the n-th light source groups respectively including at least one light emitting diode (LED), a power path controller connected to first ends of the first to the n-th light source groups and configured to selectively provide a driving power to at least one of the first to the n-th light source groups, and a ground path controller connected to the second ends of the first to the n-th light source groups and configured to control a path of a current flowing through the light source so that a number of light source groups that are driven by the driving power is adjusted based on a level of the driving power. The first to the n-th light source groups may be sequentially connected to one another and the second end of the n-th light source group may be connected to the first end of the first light source group.

The power path controller may be configured to selectively provide the driving power to one of the first to the n-th light source groups.

The power path controller may be configured to sequentially provide the driving power to the first to the n-th light source groups according to a predetermined interval, and when the driving power is provided to the n-th light source group, the driving power may be provided to the first light source group after an elapse of the predetermined interval.

The ground path controller may be configured to control the path of the current flowing through the light source such that the number of the light source groups that are driven by the driving power is increased in response to an increase in the level of the driving power.

The power path controller may include a first to an n-th power providing switches connected to the first ends of the first to the n-th light source groups, respectively, and configured to selectively provide the driving power to the respectively connected light source groups, and a power providing switch controller configured to control switching operations of the first to the n-th power providing switches.

The power providing switch controller may be configured to turn on a particular power providing switch and turn off remaining power providing switches to selectively provide the driving power to a light source group connected to the particular power providing switch.

The power providing switch controller may be configured to sequentially turn on the first to the n-th power providing switches according to a predetermined interval, and may turn on the first power providing switch after an elapse of the predetermined interval from the n-th power providing switch being turned on.

The power providing switch controller may include a timer and a shift register.

The ground path controller may include a first to an n-th ground path selection switches connected to the second ends of the first to the n-th light source groups, respectively, and configured to selectively connect the second ends of the respectively connected light source groups to a ground, and a ground path switch controller configured to control switching operations of the first to the n-th ground path selection switches.

The ground path switch controller may switch the first to the n-th ground path selection switches such that the number of the light source groups that are driven by the driving power is increased in response to an increase in the level of the driving power.

The light source may include a current path interruption portion connected between two light source groups, among the first to the n-th light source groups, and configured to block a current path between the two light source groups, and a bypass switch connected in parallel to the current path interruption portion and configured to selectively provide a current path between the two light source groups.

The light source apparatus may further include a brightness detector configured to detect external brightness, and the ground path controller may be configured to control a path of a current flowing from a light source group that receives the driving power, among the first to the n-th light source groups, to a ground, so that a maximum number of light source groups that are driven by the driving power is reduced when a degree of the detected brightness is higher than a reference value.

The light source apparatus may further include a rectifier configured to rectify alternating current (AC) power and provide a rectified driving power to the power path controller.

The light source may further include a first to an n-th sub-light source groups connected in parallel to the first to the n-th light source groups, respectively, a sub-light source group including at least one LED having a first polarity which is connected to a second polarity of at least one LED provide in a light source group connected in parallel to the sub-light source group.

According to an aspect of another exemplary embodiment, a light source driving apparatus for controlling an operation of a light source including a first to an n-th light source groups having at least one light emitting diode (LED), n being an integer of two or more, the first to the n-th light source groups being sequentially connected one another, and a first end of the first n-th light source group being connected to a second end of the n-th light source group, includes a power path controller configured to provide driving power to the light source, and a ground path controller configured to control a path of a current flowing through the light source to a ground. The power path controller may be connected to first ends of the first to the n-th light source groups, and may be configured to selectively provide the driving power to at least one of the first to the n-th light source groups. The ground path controller may be connected to second ends of the first to the n-th light source groups, and may be configured to adjust a number of light source groups that are driven according to a level of the driving power.

According to an aspect of still another exemplary embodiment, a method of driving a light source including a plurality of light source groups includes sequentially providing a driving power to the plurality of light source groups according to a predetermined time interval, the plurality of light source groups being connected to one another; and controlling a current path of the light source such that a number of a light source group that is driven by the driving power among the plurality of light source groups is adjusted based on a level of the driving power.

The plurality of light source groups may respectively include at least one light emitting diode (LED), and each of first ends of the light source groups may be connected to a second end of an adjacent light source group.

The sequentially providing may include connecting a plurality of power providing switches between a power source and the first ends of the plurality of light source groups, respectively; and controlling switching operations of the plurality of providing switches to sequentially provide the driving power from the power source to each of the plurality of light source groups according to the predetermined time interval.

The controlling may include connecting a plurality of ground path selection switches between a ground and second ends of the plurality of light source groups, respectively; and controlling switching operations of the plurality of ground path selection switches to selectively connect a light source group to a ground.

The level of the driving power may change over time, and the current path of the light source may be controlled such that respective time intervals in which the plurality of light source groups are driven by the driving power during a predetermined period of time are substantially the same.

### BRIEF DESCRIPTION OF DRAWINGS

The above and/or other aspects will become more apparent by describing certain exemplary embodiments with reference to the accompanying drawings, in which:

FIG. 1 illustrates a light source apparatus including a light source driving apparatus according to an exemplary embodiment;

FIG. 2 is a circuit diagram of the light source apparatus including the light source driving apparatus of FIG. 1 according to an exemplary embodiment;

FIG. 3 is a view of signal waveforms illustrating operations in the circuit diagram of FIG. 2;

FIGS. 4A to 4F schematically illustrate current paths according to operations in the circuit diagram of FIG. 2;

FIGS. 5A and 5B are circuit diagrams illustrating examples of a power providing switch controller and a ground path switch controller of FIG. 2;

FIG. 6 is a circuit diagram of a light source apparatus including a light source driving apparatus according to an exemplary embodiment;

FIGS. 7A and 7B are views of signal waveforms illustrating operations in the circuit diagram of FIG. 6;

FIG. 8 is a circuit diagram of a light source apparatus including a light source driving apparatus according to an exemplary embodiment;

FIG. 9 is a view of a signal waveform illustrating an operation in the circuit diagram of FIG. 8;

FIGS. 10A to 10D schematically illustrate current paths according to operations in the circuit diagram of FIG. 8;

FIG. 11 is a circuit diagram of a light source apparatus including a light source driving apparatus according to a modified example of FIG. 8;

FIG. 12 is a circuit diagram of a light source apparatus including a light source driving apparatus according to an exemplary embodiment;

FIG. 13 is a view of a signal waveform illustrating an operation in the circuit diagram of FIG. 12;

FIGS. 14 and 15 are exploded perspective views of lighting devices employing a lighting source device according to an exemplary embodiment.

### DETAILED DESCRIPTION

Certain exemplary embodiments are described in greater detail below with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

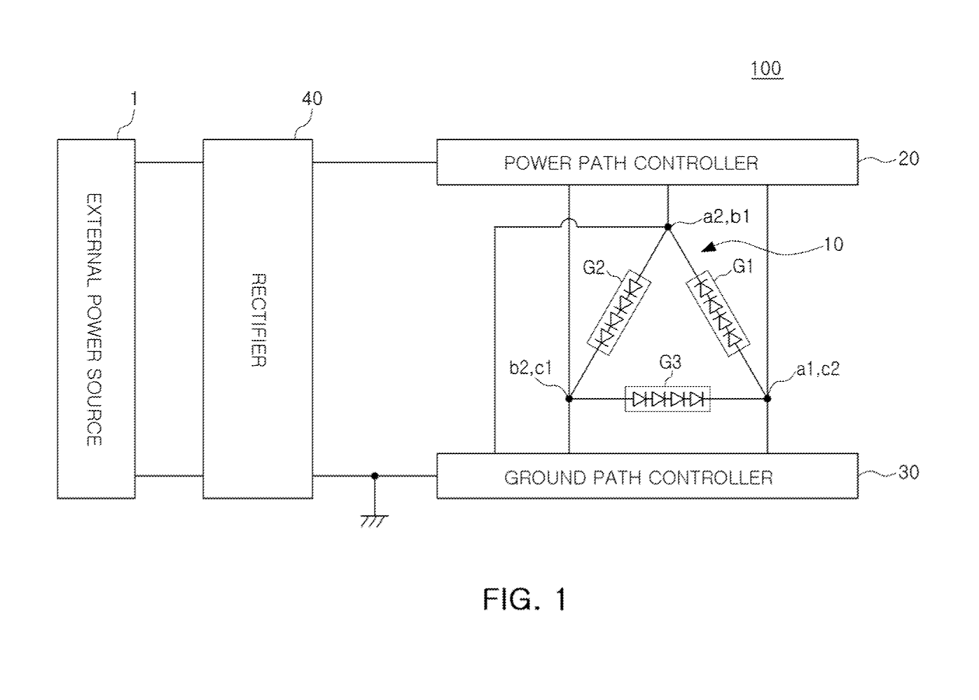

FIG. 1 illustrates a light source apparatus 100 including a light source driving apparatus according to an exemplary embodiment.

With reference to FIG. 1, a light source apparatus 100 according to an exemplary embodiment may include a rectifier 40, a light source 10, a power path controller 20 and a ground path controller 30. Here, the power path controller 20 and the ground path controller 30 are provided to control operations of the light source 10 and may be provided as a single light source driving apparatus.

The rectifier 40 may rectify alternating current power output from an external power source 1 and apply the rectified driving power to the power path controller 20. The rectified driving power may be pulsating current power having a level changed depending on a predetermined period of elapsed time, and may be, for example, sine wave direct current (DC) power, but the exemplary embodiments are not limited thereto. The rectifier 40 may be, for example, a bridge diode.

The light source 10 may be driven by driving power and may include a plurality of light source groups. The plurality of light source groups, for example, first to n-th light source groups, where n is an integer equal to or greater than two, may have two ends and may respectively include a light emitting diode (LED) array in which one or more LEDs are connected to each other in series.

In an exemplary embodiment, the first to n-th light source groups may be sequentially connected to one another from a first light source group to an n-th light source group, and an end of the n-th light source group may be connected to an end of the first light source group.

In detail, with reference to FIG. 1, the light source 10 may include first, second, and third light source groups G1, G2, and G3, each having first and second ends. Here, a second end a2 of the first light source group G1 may be connected to a first end b1 of the second light source group G2, a second end b2 of the second light source group G2 may be connected to a first end c1 of a third light source group G3, and a second end c2 of the third light source group G3 may be connected to a first end a1 of the first light source group G1.

The power path controller 20 may transfer driving power to the light source 10. In detail, the power path controller 20 may be connected to respective first ends of the first to n-th light source groups to transfer driving power, applied from the rectifier 40, to at least one of the first ends of the first to n-th light source groups.

According to an exemplary embodiment, the power path controller 20 may exclusively and/or selectively transfer the driving power to a first end of a light source group among the first to n-th light source groups, according to a predetermined interval. Although not limited thereto, the power path controller 20 may sequentially transfer the driving power to the first to n-th light source groups, and when the driving power is transferred to the n-th light source group, the power path controller 20 may repeat a process of transferring the driving power to the first light source group after a predetermined interval has elapsed.

For example, referring to FIG. 1, the power path controller 20 may transfer the driving power to only the first end a1 of the first light source group G1 during a predetermined interval T from an initial operating time point, for example, during an interval from 0 to 1T. During the interval 1T, although the driving power is provided to only the first end a1 of the first light source group G1, since the second end a2 of the first light source group G1 and the first end b1 of the second light source group G2 are connected to each other, at least the first and second light source groups G1 and G2 may emit light according to a path of a current flowing through the light source 10 to a ground.

Subsequently, when the predetermined interval T elapses, the power path controller 20 may transfer driving power to only the first end b1 of the second light source group G2, for example, during an interval between 1T and 2T. In this case, at least the second and third light source groups G2 and G3 may emit light according to a current path from the light source 10 to a ground, in a similar manner to the case of providing the driving power to only the first end a1 of the first light source group G1 as described above.

Next, when the predetermined interval T elapses, the power path controller 20 may transfer the driving power to only the first end c1 of the third light source group G3 during an interval between 2T and 3T. In this case, at least the third and first light source groups G3 and G1 may emit light. In addition, when the predetermined interval T elapses again, the power path controller 20 may transfer the driving power to only the first end a1 of the first light source group G1, for example, during an interval between 3T and 4T, and the above described procedure may be repeated.

The ground path controller 30 may be connected to respective second ends of the first to n-th light source groups to form a path of a current flowing through the light source 10 to a ground. Here, the ground path controller 30 may control the current path such that the number of light source groups driven by the light source 10 may be changed according to a level of the driving power transferred to the light source 10. By the operation of the ground path controller 30, the number of driven light source groups may be sequentially increased in response to an increase in the level of the driving power transferred to the light source 10.

For example, with reference to FIG. 1, during the interval from 0 to 1T, driving power may be transferred to the first end a1 of the first light source group G1 as described above. In this case, when a level of the driving power is sufficient to drive only one light source group due to threshold voltage characteristics of a plurality of LEDs provided in the light source 10, the ground path controller 30 may control a current path such that a current flowing in the light source 10 may pass through the first end a1 of the first light source group G1 and flow to a ground through the second end a2 thereof.

On the other hand, for example, when the level of the driving power is sufficient to drive two or more light source groups, the ground path controller 30 may control a current path such that a current flowing in the light source 10 may pass through the first end a1 of the first light source group G1, the second end a2 of the first light source group G1, which is connected to the first end b1 of the second light source group G2, and the second end b2 of the second light source group G2, and may flow to a ground.

Similarly, the ground path controller 30 may control a current path such that during the interval between 1T and 2T, according to a level of the driving power, the current may flow to the ground by passing through the first end b1 of the second light source group G2 and through the second end b2 of the second light source group G2, or the current may flow to the ground by passing through the first end b1 of the second light source group G2, the second end b2 of the second light source group G2, which is connected to the first end c1 of the third light source group G3, and through the second end c2 of the third light source group G3.

In addition, similarly to the case of the interval between 1T and 2T, the ground path controller 30 may also control a current path such that during the interval between 2T and 3T, according to a level of the driving power, the current may flow to a ground by passing through the first end c1 of the third light source group G3 and through the second end c2 of the third light source group G3, or the current may flow to the ground by passing through the first end c1 of the third light source group G3, the second end c2 of the third light source group G3, which is connected to the first end a1 of the first light source group G1, and through the second end a2 of the first light source group G1.

According to an exemplary embodiment, since a constant current circuit does not need to be included in the light source apparatus 100, a relatively simplified circuit configuration and device miniaturization may be implemented. In addition, since a lifespan of a plurality of respective light source groups may decrease at a comparatively uniform rate while sequentially driving light source groups by driving power having a level that varies over time, overall average lifespans of the light source apparatus 100 may be extended.

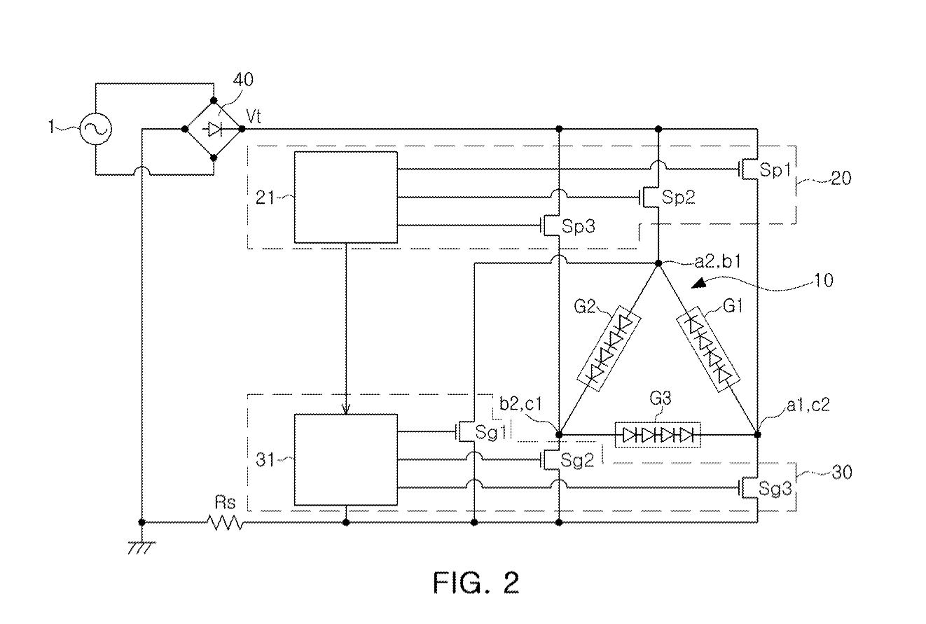

Hereinafter, the light source apparatus 100 including the light source driving apparatus according to the exemplary embodiment of FIG. 1 will be described in further detail with reference to FIGS. 2 to 4F.

FIG. 2 is a circuit diagram of the light source apparatus 100 including a light source driving apparatus according to the exemplary embodiment of FIG. 1.

With reference to FIG. 2, the power path controller 20 may include first to third power providing switches Sp1, Sp2, and Sp3 and a power providing switch controller 21. The first to third power providing switches Sp1, Sp2, and Sp3 may be connected to first ends a1, b1, and c1 of the first to third light source groups G1, G2, and G3, respectively, to transfer the driving power to the respectively connected light source groups according to switching operations thereof. The power providing switch controller 21 may control on and/or off switching of the first to third power providing switches Sp1, Sp2, and Sp3.

The ground path controller 30 may include first to third ground path selection switches Sg1, Sg2, and Sg3 and a ground path switch controller 31. The first to third ground path selection switches Sg1, Sg2, and Sg3 may be connected to the second ends a2, b2, and c2 of the first to third light source groups G1, G2, and G3, respectively, such that the second ends a2, b2, and c2 of the respectively connected light source groups may be connected to the ground according to switching operations thereof. The ground path switch controller 31 may control on and/or off switching of the first to third power providing switches Sp1, Sp2, and Sp3.

The ground path switch controller 31 may detect a level of power flowing through the light source 10 to the ground. For example, the ground path switch controller 31 may detect a voltage applied to a first end of a sensing resistor Rs of which a second end is connected to the ground and may control a current path to increase the number of the light source groups driven by the light source 10 when the detected voltage level is equal to or higher than a reference value. However, the exemplary embodiments are not limited thereto.

Although it is described that the light source apparatus includes three light source groups G1, G2, G3, in the above exemplary embodiment, it should be noted that the light source apparatus according to exemplary embodiments may include any number of light source groups. Also, a number of the power providing switches and the ground path selection switches may vary according to the number of light source groups.

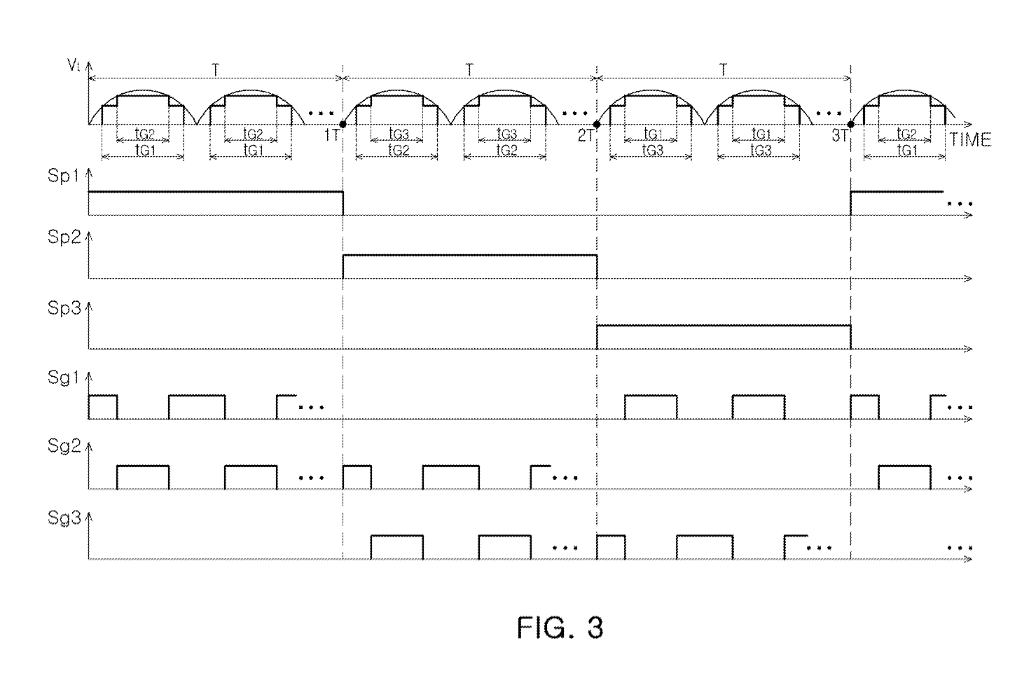

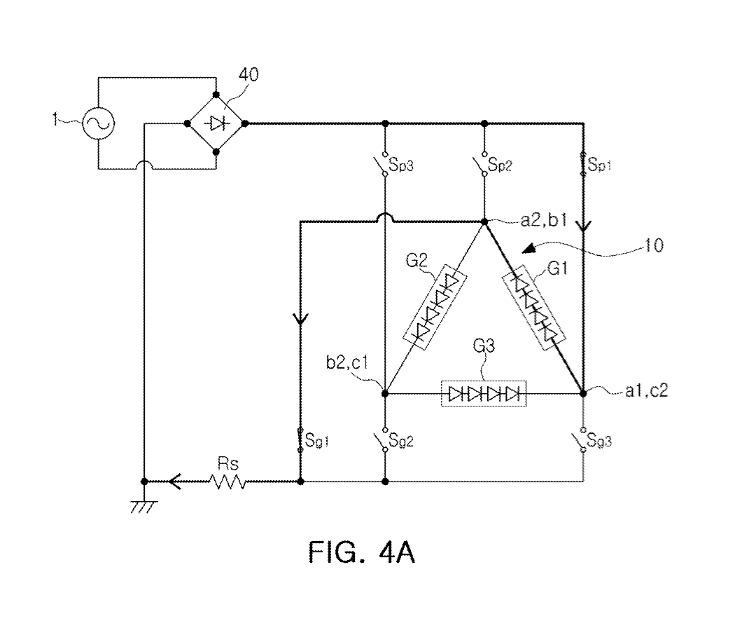

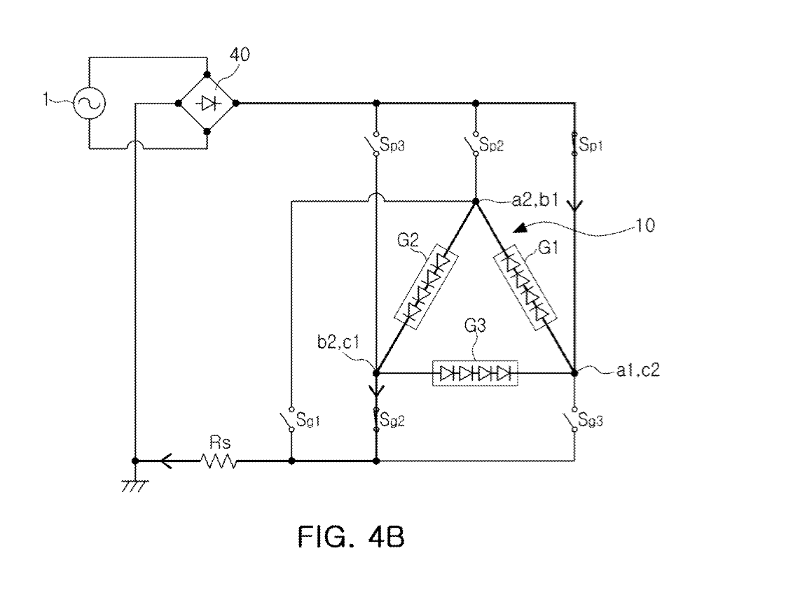

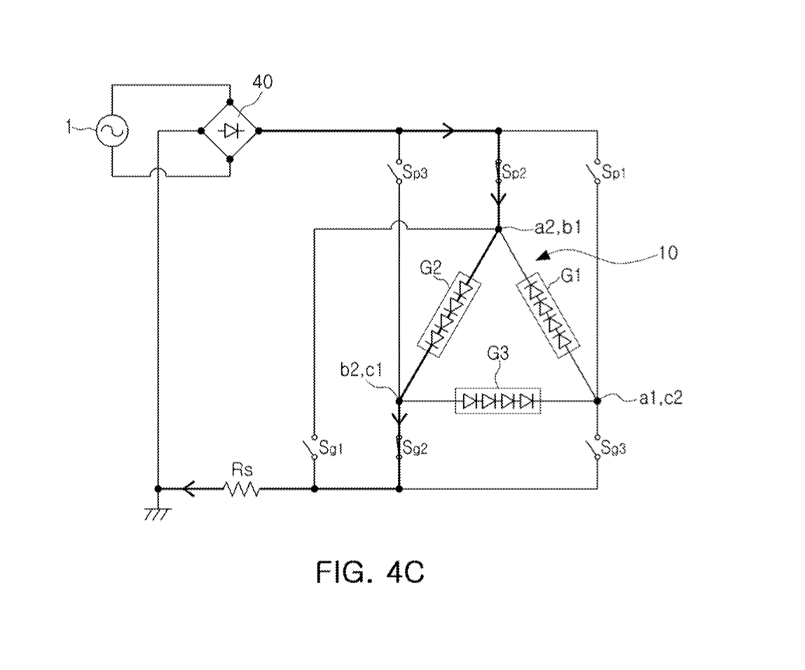

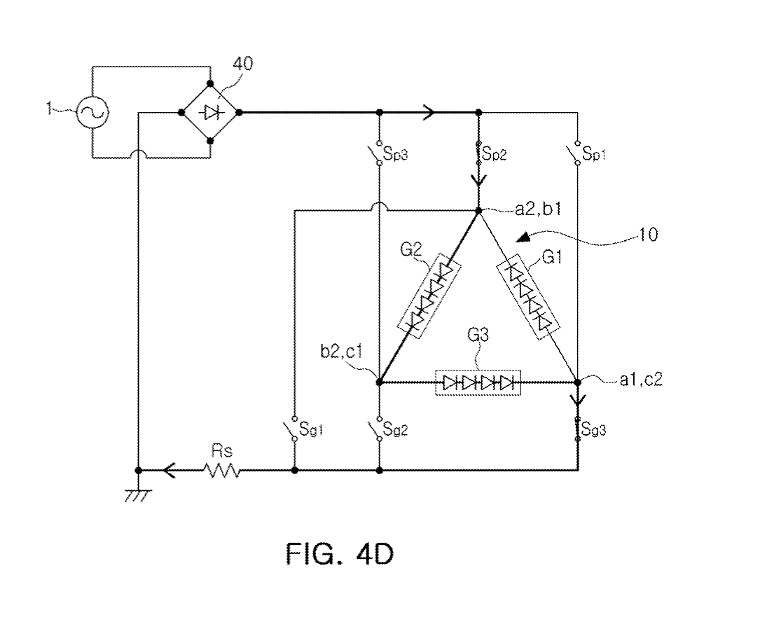

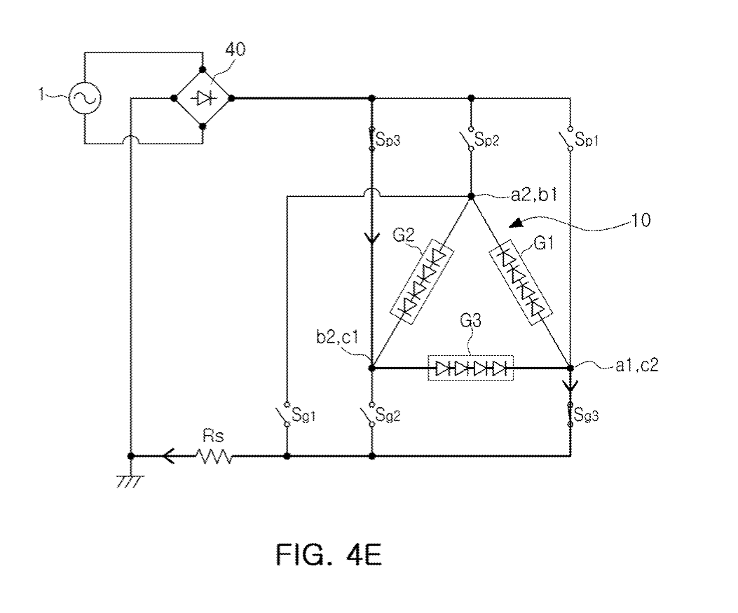

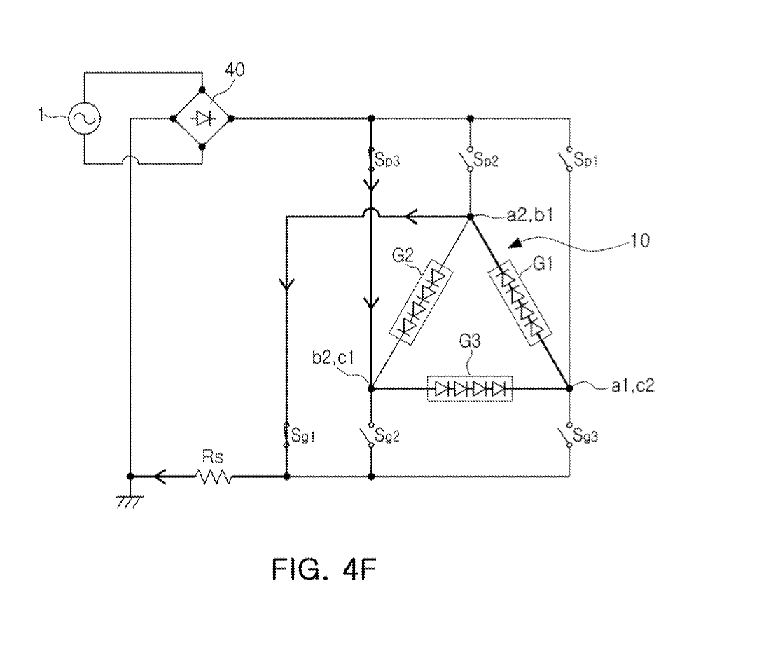

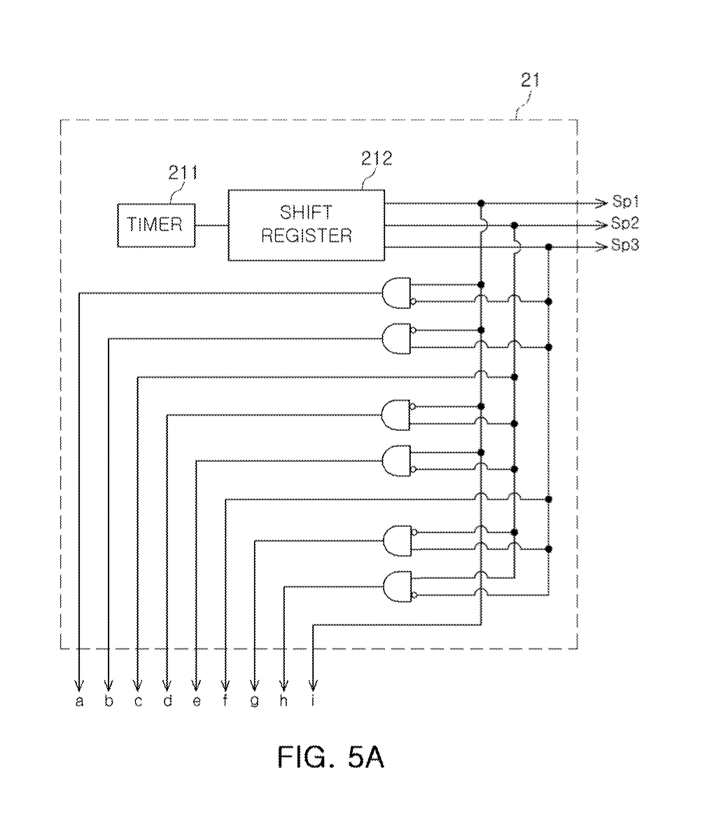

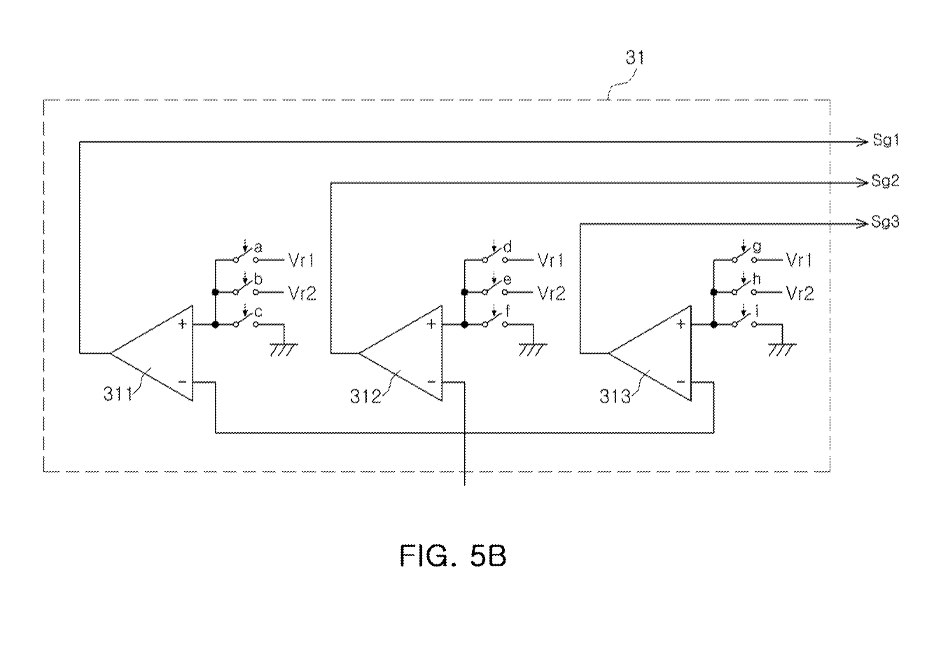

Hereinafter, examples of the power providing switch controller 21 and the ground path switch controller 31 will be further described later with reference to FIGS. 5A and 5B, and operations of the light source apparatus 100 illustrated in FIG. 2 will be described with reference to FIGS. 3 and 4A to 4F.

FIG. 3 is a view of signal waveforms illustrating operations in the circuit diagram of FIG. 2. FIGS. 4A to 4F schematically illustrate current paths according to operations in the circuit diagram of FIG. 2.

With reference to FIG. 3, the power path controller 20 may transfer driving power only to the first end a1 of the first light source group G1 during an interval between 0 and 1T, for example, from an initial operating time point 0 to a predetermined time T. In this case, the power providing switch controller 21 may switch on the first power providing switch Sp1 connected to the first end a1 of the first light source group G1 and may switch off the second power providing switch Sp2 and the third power providing switch Sp3.

The driving power transferred to the light source 10 may be alternating current (AC) power that is full-wave rectified by the rectifier 40, and a level Vt of the driving power may be changed over time, as shown in FIG. 3. Here, the ground path switch controller 31 may switch the first to n-th ground path selection switches to sequentially increase the number of the light source groups, among the first to n-th light source groups, which emit light by a current flowing from a light source group receiving the driving power to the ground.

In detail, for example, in a case in which the level of the driving power in the interval from 0 to 1T is a level enough to drive only one light source group among the first to third light source groups G1 to G3 provided in the light source 10, the ground path switch controller 31 may switch on the first ground path selection switch Sg1 and switch off the second ground path selection switch Sg2 and the third ground path selection switch Sg3. In this case, as illustrated in FIG. 4A, the current flowing in the light source 10 may pass through the first end a1 of the first light source group G1 and the second end a2 thereof to flow to the ground, and in this case, only the first light source group G1 may emit light.

Next, when the level of the driving power is increased to be sufficient to drive two or more light source groups, the ground path switch controller 31 may switch on the second ground path selection switch Sg2 and may switch off the first and third ground path selection switches Sg1 and Sg3. In this case, as illustrated in FIG. 4B, the current flowing in the light source 10 may pass through the first end a1 of the first light source group G1, the second end a2 thereof, the first end b1 of the second light source group G2, and the second end b2 of the second light source group G2 to flow to the ground. In this case, the first and second light source groups G1 and G2 may emit light.

Subsequently, when the predetermined interval T elapses, for example, during the interval between 1T and 2T, the power path controller 20 may transfer the driving power only to the first end b1 of the second light source group G2. The power providing switch controller 21 may switch on the second power providing switch Sp2 connected to the first end b1 of the second light source group G2 and may switch off the remaining first and third power providing switches Sp1 and Sp3 off, as illustrated in FIG. 4C.

Here, when the level of the driving power is equal to or less than a reference value during the interval between 1T and 2T, the ground path switch controller 31 may switch on the second ground path selection switch Sg2 and switch off the first and third ground path selection switches Sg1 and Sg3. In this case, the current flowing in the light source 10 may pass from the first end b1 of the second light source group G2 through the second end b2 thereof to the ground, as shown in FIG. 4C. Thus, only the second light source group G2 may emit light.

Next, when the level of the driving power is equal to or higher than a reference value, the ground path switch controller 31 may switch off the first and second ground path selection switches Sg1 and Sg2 and switch on the third ground path selection switch Sg3. Thus, the current flowing in the light source 10 may pass through the first end b1 of the second light source group G2, the second end b2 thereof, which is connected to the first end c1 of the third light source group G3, and through the second end c2 of the third light source group G3 to the ground, as illustrated in FIG. 4D. In this case, the second and third light source groups G2 and G3 may emit light.

Similarly, when the predetermined interval T elapses, for example, during the interval between 2T and 3T, the power path controller 20 may switch on only the third power providing switch Sp3, using the power providing switch controller 21, to transfer driving power only to the first end c1 of the third light source group G3.

The ground path switch controller 31 may switch off the first and second ground path selection switches Sg1 and Sg2 and switch on the third ground path selection switch Sg3 according to a level of the driving power within the interval between 2T and 3T. Thus, the current flowing in the light source 10 may pass from the first end c1 of the third light source group G3, the second end c2 thereof, to the ground, as illustrated in FIG. 4E.

In addition, as the level of the driving power is increased, the third ground path selection switch Sg3 may be switched off and the first ground path selection switch Sg1 may be switched on, so that a current path as illustrated in FIG. 4F may be provided.

Subsequently, when the predetermined interval T elapses again, the power providing switch controller 21 may switch on only the first power providing switch Sp1, and the above-described procedure may be repeated.

In the related art, in the case of a light source apparatus including a plurality of light source groups sequentially driven according to a power level of the driving power, since a light source group driven by a lowest power level of driving power may have a relatively long period of driving time compared to that of other light source groups, the lifespan thereof may decrease more rapidly than other light source groups.

However, according to an exemplary embodiment, since a light source group driven at a lowest power level of the driving power is changed according to a preset condition, a problem that the lifespan of a specific light source group among the plurality of light source groups decreases first may be avoided (see tG1, tG2, tG3 of FIG. 3, respectively respecting time intervals in which the first to third light source groups G1 to G3 are driven by the driving power). Although the preset condition has been illustrated as being a predetermined interval or time, the exemplary embodiments are not limited thereto.

In addition, according to an exemplary embodiment, a respective light source group may have an inactive period in which the light source group does not emit light for a specific period. For example, with reference to FIG. 3, the first light source group G1 may have an inactive period without emitting light during the interval between 1T and 2T. In this case, the plurality of respective light source groups may effectively radiate heat generated when being driven in the inactive period, thereby avoiding reduction in a lifespan of a device due to overheating and the like.

The power providing switch controller 21 and the ground path switch controller 31 illustrated in FIG. 2 will be described in more detail with reference to FIGS. 5A and 5B.

With reference to FIG. 5A, the power providing switch controller 21 may include a timer 211 and a shift register 212. When a predetermined interval elapses according to time information provided by the timer 211, the shift register 212 may sequentially and repeatedly output control signals. For example, the shift register 212 may sequentially and repeatedly output first through third controls signals having respectively high, low, and low levels, low, high, and low levels, and low, low, and high levels. In this case, the first to third power providing switches Sp1 to Sp3 may repeatedly perform on/off switching in response to high and low levels of the first through third control signals output from the shift register 212.

With reference to FIG. 5B, the ground path switch controller 31 may include a plurality of comparators. The plurality of comparators may include first to n-th comparators to correspond to the number of the light source groups. FIG. 5B illustrates a case where the ground path switch controller 31 includes first to third comparators 311, 312 and 313. The comparators 311, 312 and 313 may include a comparator or an operational amplifier (OP Amp).

Inverting input terminals of the plurality of comparators may be connected to the first end of the sensing resistor Rs, but are not limited thereto. The non-inverting input terminals of the plurality of comparators may be connected to one of a first reference voltage Vr1, a second reference voltage Vr2, and a ground by switching operations of switches controlled by comparator control signals a to i. Here, a level of the second reference voltage Vr2 may, for example, be higher than that of the first reference voltage Vr1.

With reference to FIGS. 5A and 5B, operations of the light source apparatus 100 according to an exemplary embodiment will be described. First, during the interval from 0 to 1T, the shift register 212 may output the first through third control signals respectively having high, low, low levels such that only the first power providing switch Sp1 may be switched on, and driving power may be transferred to the first end a1 of the first light source group G1.

In addition, the comparator control signals a to i may have high, low, low, low, high, low, low, low, and high levels, respectively. By switching operations controlled by the comparator control signals a to i, the non-inverting input terminals of the first and second comparators 311 and 312 may be connected to the first reference voltage Vr1 and the second reference voltage Vr2, respectively. The non-inverting input terminal of the third comparator 313 may be connected to the ground and output a low level signal. Thus, the third ground path selection switch Sg3 may be switched off in the entire interval from 0 to 1T.

During the interval from 0 to 1T, for example, when a level of voltage applied to the sensing resistor Rs is lower than that of the first reference voltage Vr1, the first comparator 311 may output a high level signal to switch on the first ground path selection switch Sg1. Accordingly, a path of a current flowing through the light source 10 to the ground may be represented as illustrated in FIG. 4A, and only the first light source group G1 may emit light.

On the other hand, during the interval from 0 to 1T, for example, when a level of the voltage applied to the sensing resistor Rs is higher than that of the first reference voltage Vr1 but lower than that of the second reference voltage Vr2, the first comparator 311 and the second comparator 312 may output a low level signal and a high level signal, respectively. Accordingly, the first ground path selection switch Sg1 may be switched off, and the second ground path selection switch Sg2 may be switched on, a path of a current flowing through the light source 10 to the ground may be represented as illustrated in FIG. 4B, and the first and second light source groups G1 and G2 may emit light together.

Further, for example, when a level of the voltage applied to the sensing resistor Rs is increased to be higher than that of the second reference voltage Vr2, the first to third comparators 311 to 313 may output a low level signal, and all of the first to third ground path selection switches Sg1 to Sg3 may be switched off, so as not to form a current path. Thus, LEDs provided in the light source groups may be protected from an overcurrent.

In a similar manner, during the interval between 1T and 2T, the shift registers 212 may output signals respectively having low, high, low levels. Thus, only the second power providing switch Sp2 may be switched on such that driving power may be transferred to the first end b1 of the second light source group G2. In this case, comparator control signals a to i may have low, low, high, high, low, low, low, high and low levels, respectively, and thus, the non-inverting input terminals of the first to third comparators 311 to 313 may be connected to the ground, the first reference voltage Vr1, and the second reference voltage Vr2, respectively. Thus, in the light source apparatus 100, a current path may be formed according to a level of driving power (for example, a level of voltage applied to the first end of the sensing resistor Rs) provided to the light source 10 as illustrated in FIG. 4C or 4D.

In a similar manner, during the interval between 2T and 3T, the shift registers 212 may output low, low, high signals, and the power path controller 20 may transfer the driving power to only the first end cl of the third light source group G3. In addition, control signals a to i may have low, high, low, low, low, high,-high, low, and low levels, respectively, and thus, the non-inverting input terminals of the first to third comparators 311 to 313 may be connected to the second reference voltage Vr2, the ground, and the first reference voltage Vr1, respectively. In this case, current paths as illustrated in FIGS. 4E and 4F may be formed according to a level of the driving power provided by the light source 10.

Embodiments of FIGS. 5A and 5B are given only for examples, and the power providing switch controller 21 and the ground path switch controller 31 are not limited thereto. For example, the power providing switch controller 21 and the ground path switch controller 31 may be implemented by a microprocessor or a central processing unit (CPU) capable of performing switching control as described above, and the like.

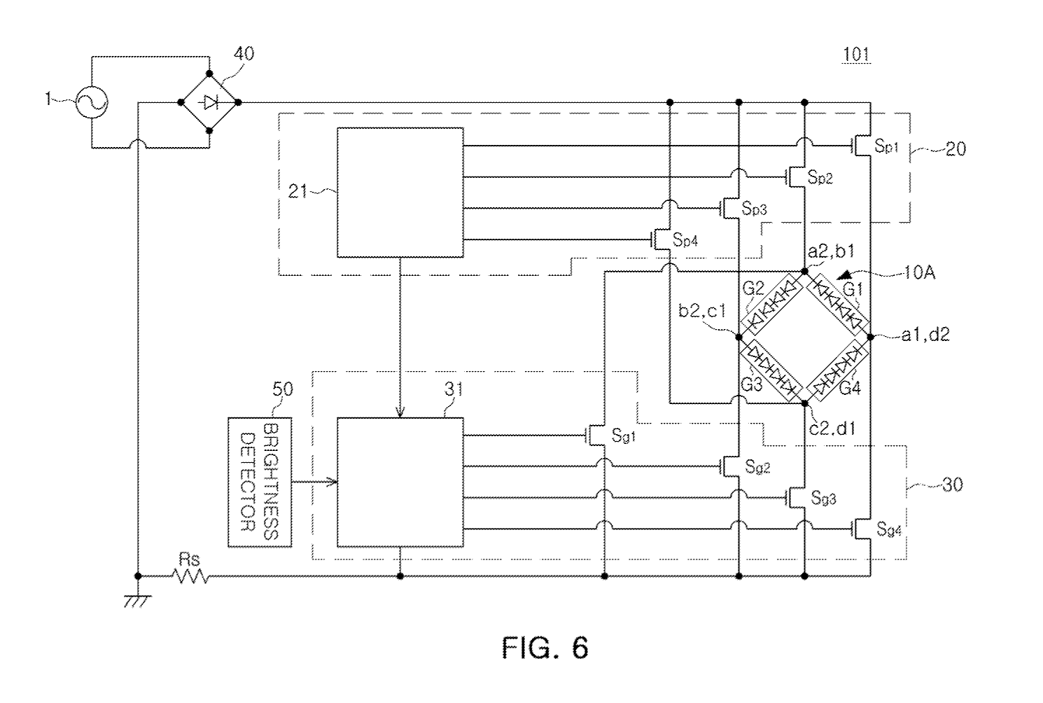

FIG. 6 is a circuit diagram of a light source apparatus 100 including a light source driving apparatus according to an exemplary embodiment. Hereinafter, descriptions of the same or similar configurations that have been already described in the foregoing exemplary embodiments will be omitted, and different configurations will mainly be described.

With reference to FIG. 6, a light source 10A may include first to fourth light source groups G1 to G4.

A power path controller 20 may include first to fourth power providing switches Sp1 to Sp4 connected to first ends a1, b1, c1, and d1 of the first to fourth light source groups G1 to G4, respectively, and a power providing switch controller 21 controlling switching operations thereof.

A ground path controller 30 may include first to fourth ground path selection switches Sg1 to Sg4 connected to second ends a2, b2, c2, and d2 of the first to fourth light source groups G1 to G4, respectively, and a power providing switch controller 31 controlling switching operations thereof.

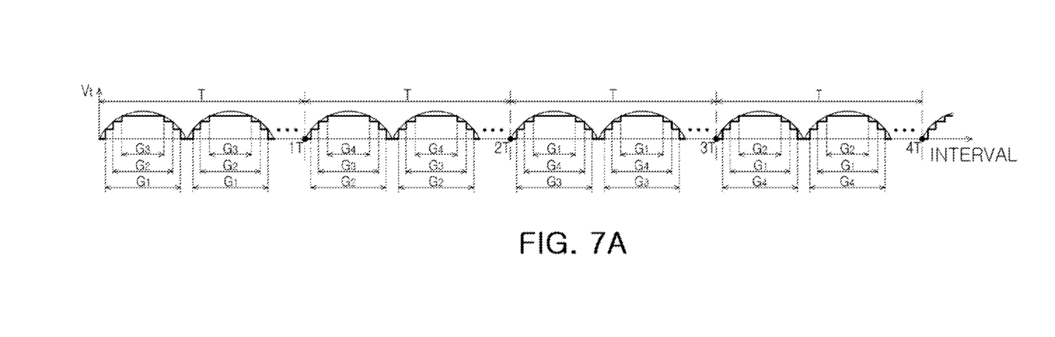

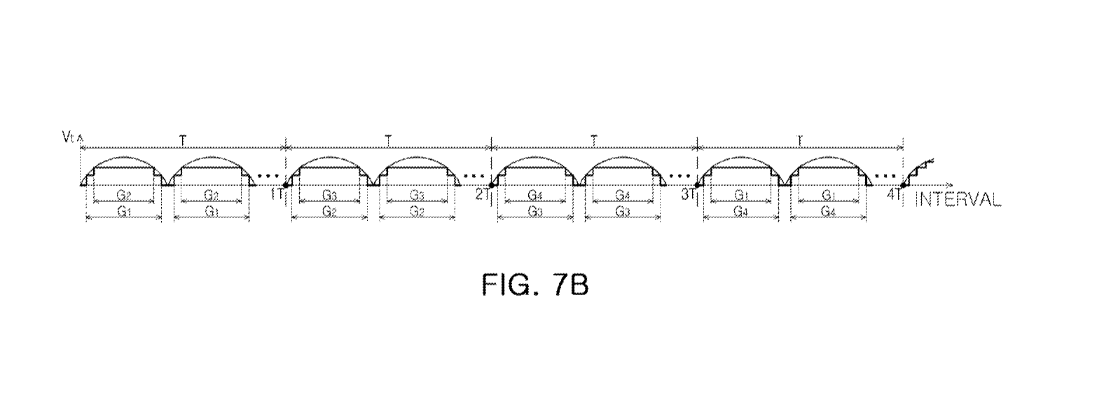

Referring to FIG. 6 and FIG. 7A, in a light source apparatus 101 according to an exemplary embodiment, the power path controller 20 may sequentially transfer driving power to the first ends a1, b1, c1, and d1 of the first to fourth light source groups G1 to G4 according to a predetermined interval T.

As a level of driving power transferred to the light source 10A is increased, the ground path controller 30 may control a path of current that flows from a light source group having received the driving power, among the first to fourth light source groups G1 to G4, to a ground, to allow for a sequential increase in the number of light source groups being driven. Thus, in a case in which the driving power is transferred to the first end a1 of the first light source group G1, a state in which light is emitted may be changed according to a level of driving power. For example, the light source groups G1, G2, and G3 may be controlled such that only the first light source group G1 may emit light, the first and second light source groups G1 and G2 may emit light, or the first to third light source groups G1 to G3 may emit light, according to the level of driving power.

In an exemplary embodiment, the light source apparatus 101 may include a brightness detector 50 detecting external brightness. The brightness detector 50 may be located in a position such that the brightness detector 50 may be less affected by light emitted by the light source 10A and effectively detect whether the light source apparatus 101 is present in a relatively bright environment or a relatively dark environment.

When a degree of brightness detected by the brightness detector 50 is higher than a reference value, the light source apparatus 101 may be determined as being located in a relatively bright environment. Thus, in a case in which the detected brightness has a level equal to or higher than a reference value, the ground path controller 30 may control a current path so that a maximum number of light source groups driven by the light source 10A may be reduced.

For example, with reference to FIGS. 7A and 7B, a maximum number of light source groups capable of emitting light within respective intervals may be three as illustrated in FIG. 7A, and in a case in which a level of the detected brightness is equal to or higher than a reference value, a maximum number of light source groups capable of emitting light within respective intervals may be changed to two as illustrated in FIG. 7B. The maximum number of light source groups may be controlled by controlling a path of current flowing from a light source group having received the driving power, among the first to n-th light source groups, to the ground, as described above in the foregoing exemplary embodiments.

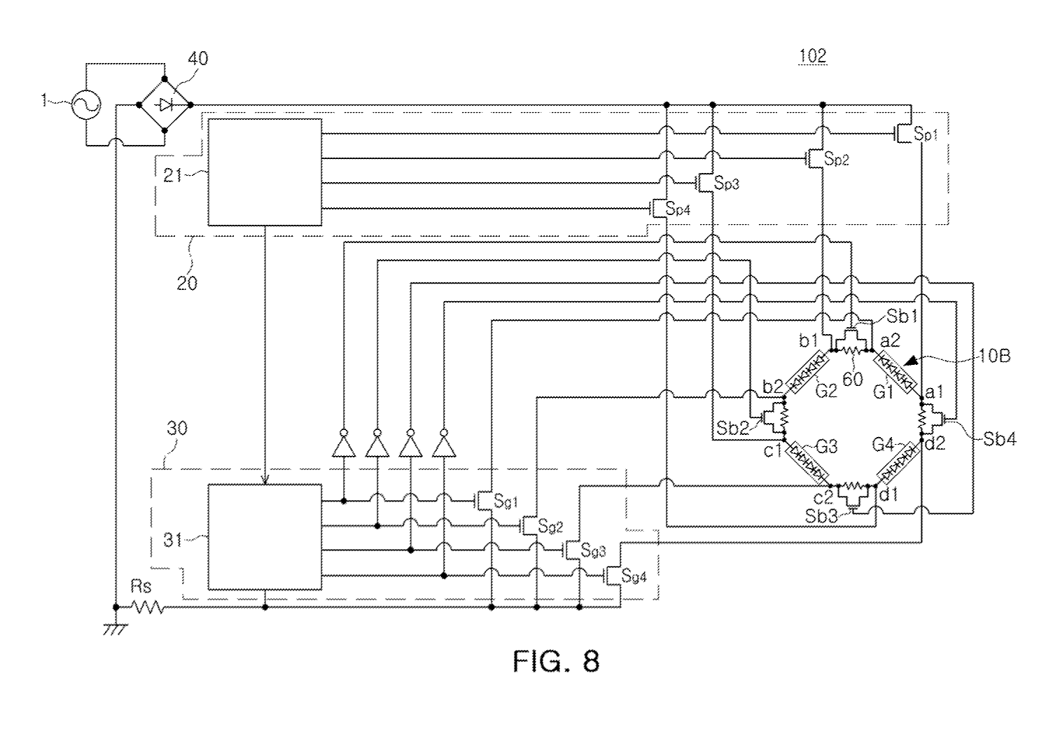

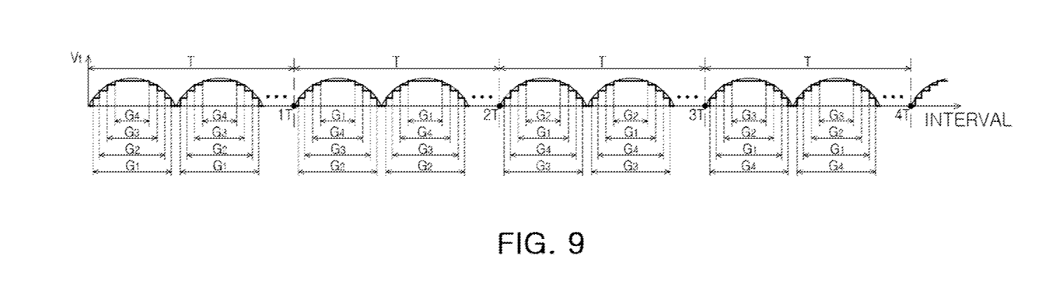

FIG. 8 is a circuit diagram of a light source apparatus 102 including a light source driving apparatus according to an exemplary embodiment. FIG. 9 is a view of a signal waveform illustrating an operation in the circuit diagram of FIG. 8

In an exemplary embodiment, a light source 10B may include current path interruption portions 60 respectively connected between light source groups among the first to n-th light source groups, and bypass switches respectively connected in parallel to the current path interruption portions 60.

In detail, as illustrated in FIG. 8, the light source 10B may include first to fourth current path interruption portions 60. The first current path interruption portion 60 may be connected between the first light source group G1 and the second light source group G2. The second current path interruption portion 60 may be connected between the second light source group G2 and the third light source group G3, and the third and fourth current path interruption portions 60 may also be connected in a similar manner. In an exemplary embodiment, the plurality of current path interruption portions 60 may be provided as resistance portions. The resistance portions may include elements such as an open circuit formed due to circuit cutoff.

In the foregoing exemplary embodiments, a maximum number of light source groups driven during a single interval, for example, 0˜1T, 1T˜2T, 2T˜3T, or the like, is controlled to be less than a total number of light source groups provided in the light source 10B. For example, in an exemplary embodiment with reference to FIG. 6, a maximum number of driven light source groups is controlled not to be higher than three. On the other hand, an exemplary embodiment in FIG. 9 may have an advantage in that a maximum number, for example, four, of driven light source groups, may be equal to a total number, for example, four, of light source groups provided in the light source 10B.

In detail, in an exemplary embodiment, when driving power is transferred to a first end a1 of the first light source group G1 during the interval 0˜1T, a maximum number of light source groups, for example, first to fourth light source groups G1 to G4 may sequentially emit light according to a level of the driving power (see G1 to G4 of FIG. 9).

In addition, when the driving power is transferred to a second end b1 of the second light source group G2 during the interval 1T˜2T, second, third, fourth, and first light source groups G2, G3, G4, and G1 may sequentially emit light according to a level of the driving power. In consecutive intervals 2T˜3T, 3T˜4T, or the like, the light source groups may operate in a similar manner.

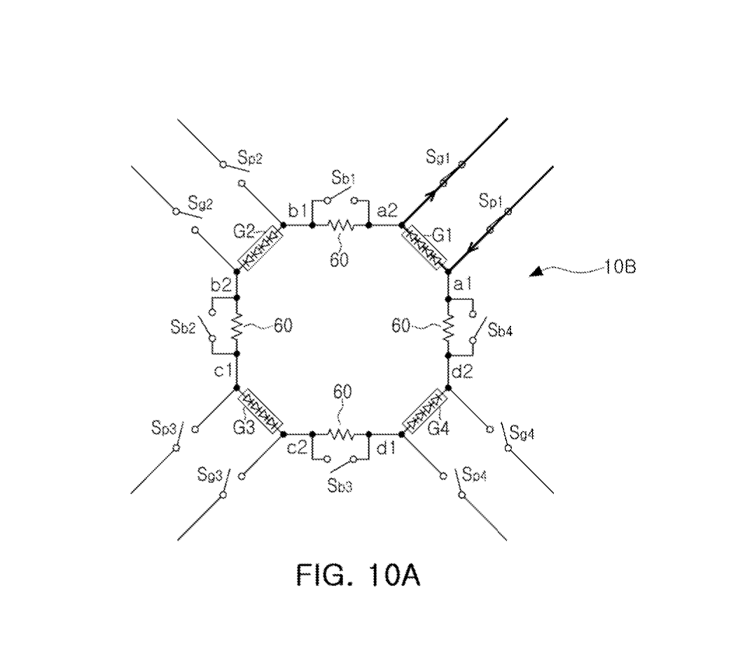

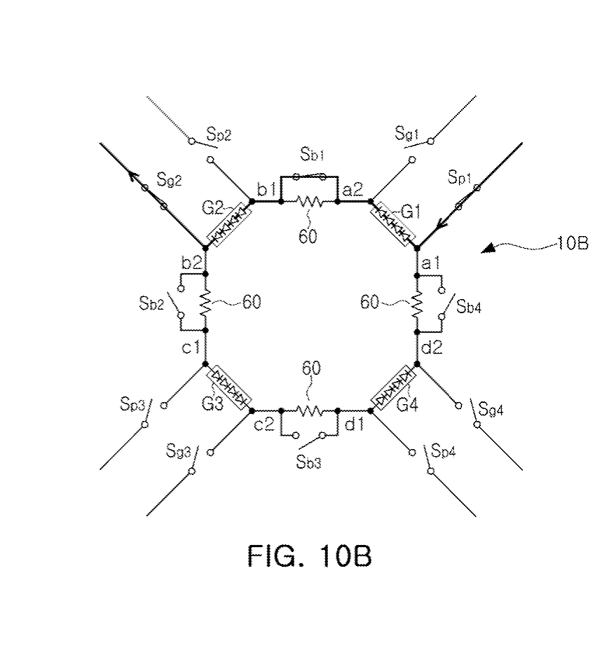

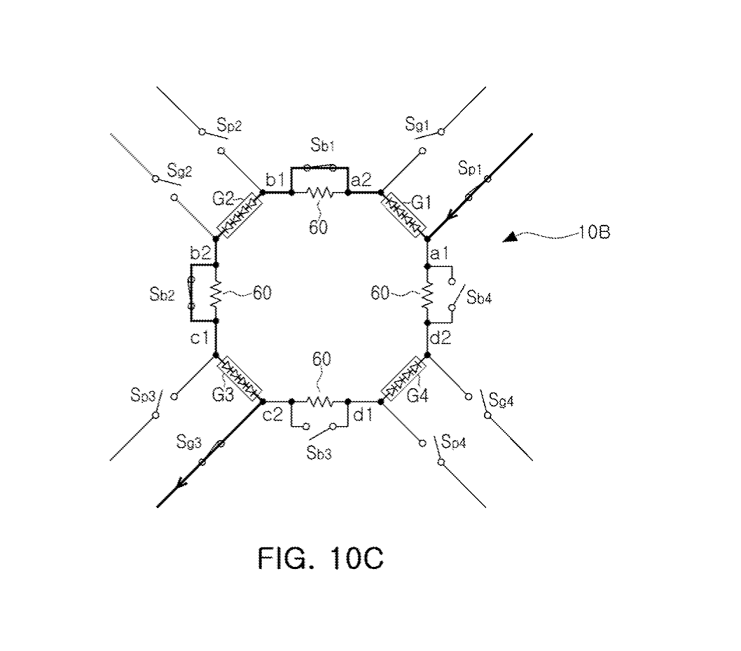

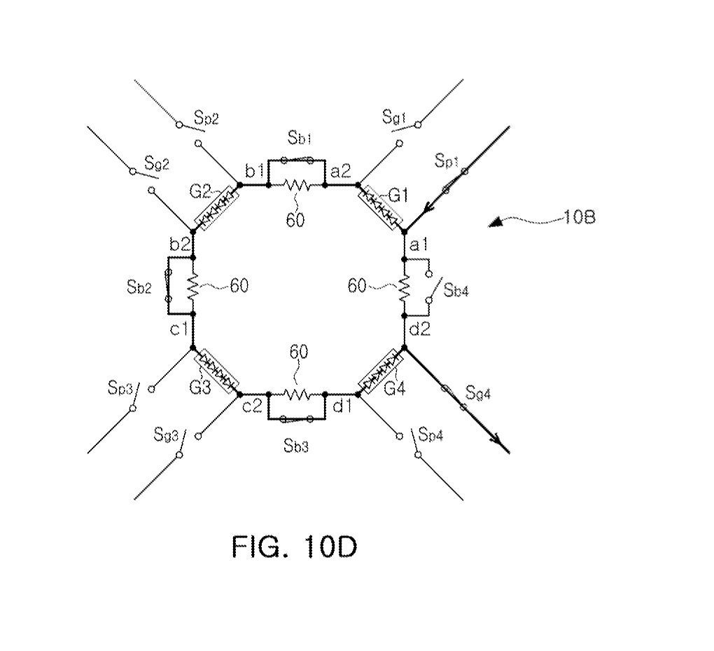

Operations of the light source apparatus 102 according to the exemplary embodiment of FIG. 8 will be described in further detail with reference to FIGS. 10A to 10D.

FIGS. 10A to 10D schematically illustrate current paths according to operations in the circuit diagram of FIG. 8. Here, the operations will be described based on a state in which driving power is transferred to a first end a1 of the first light source group G1. Cases in which driving power is transferred to first ends b1, c1, and d1 of the remaining second to fourth light source groups G2 to G4 may also be operated in a similar manner as the case of the first light source group G1 described below.

For example, when a level of driving power transferred to the light source 10B is sufficient to drive only one light source group among a plurality of light source groups, the ground path controller 30 may switch on the first ground path selection switch Sg1. Here, a current flowing in the light source 10B may pass through the first end a1 of the first light source group G1 and through the second end a2 of the first light source group G1, to flow to a ground, as illustrated in FIG. 10A, and in this case, only the first light source group G1 may emit light.

Next, for example, when the level of the driving power is higher than a first reference value, the ground path controller 30 may switch on the second ground path selection switch Sg2 and switch off the first ground path selection switch Sg1. Here, a first bypass switch Sb1 connected in parallel to the first current path interruption portion 60 may be switched on. Thus, a path of current flowing from the second end a2 of the first light source group G1 to the first end b1 of the second light source group G2 may be formed, as shown in FIG. 10B.

Further, the current flowing in the light source 10B may pass through the first end a1 of the first light source group G1, the second end a2 thereof, the first end b1 of the second light source group G2, and through the second end b2 of the second light source group G2, to flow to the ground, as illustrated in FIG. 10B.

Subsequently, for example, when the level of the driving power is higher than a second reference value, the ground path controller 30 may switch on the third ground path selection switch Sg3 and switch off the second ground path selection switches Sg1 and Sg2. Here, the first bypass switch Sb1 and a second bypass switch Sb2 respectively connected in parallel to the first and second current path interruption portions 60 may be switched on, such that a current may be conducted between light source groups adjacently connected to each other. In this case, the current flowing in the light source 10B may pass through the first end a1 of the first light source group G1 and through the second end c2 of the third light source group G3 to flow to the ground, as illustrated in FIG. 10C.

In a similar manner, for example, when the level of the driving power is higher than a third reference value, the ground path controller 30 may switch on the fourth ground path selection switch Sg4 and switch off the first to third ground path selection switches Sg1 to Sg3. Here, the first to third bypass switches Sb1 to Sb3 respectively connected in parallel to the first to third current path interruption portions 60 may be switched on. Since a fourth bypass switch Sb4 is in a switched-off state, the current flowing in the light source 10B may pass through the first end a1 of the first light source group G1 and through the second end d2 of the fourth light source group G4 to flow to the ground, as illustrated in FIG. 10D.

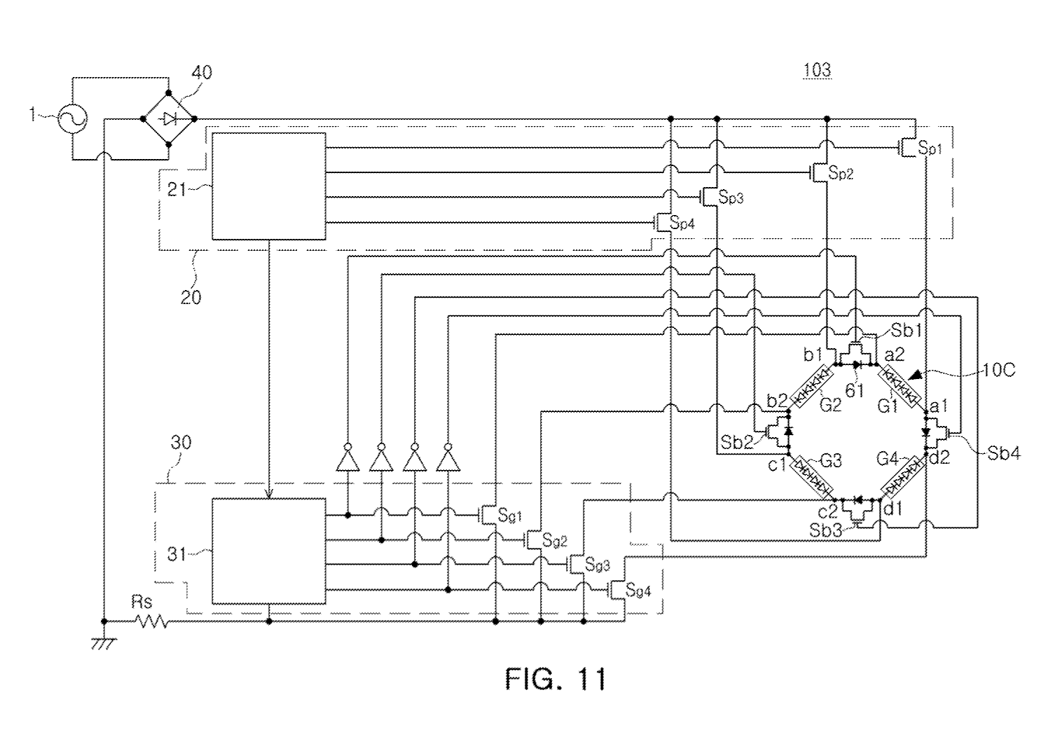

FIG. 11 is a circuit diagram of a light source apparatus 103 including a light source driving apparatus according to a modified example of FIG. 8.

The exemplary embodiment with reference to FIG. 11 is substantially the same to the exemplary embodiment of FIG. 8 except that a light source 10C employs a diode as a current path interruption portion 61.

As illustrated in FIG. 11, the current path interruption portion 61 may be a diode connected to the light source groups such that the same polarity of the diode as that of LEDs provided in the first to n-th light source groups is coupled thereto. Since a diode has a characteristic of conducting a current in a single direction, the diode may be employed to replace the resistance portion illustrated in FIG. 8.

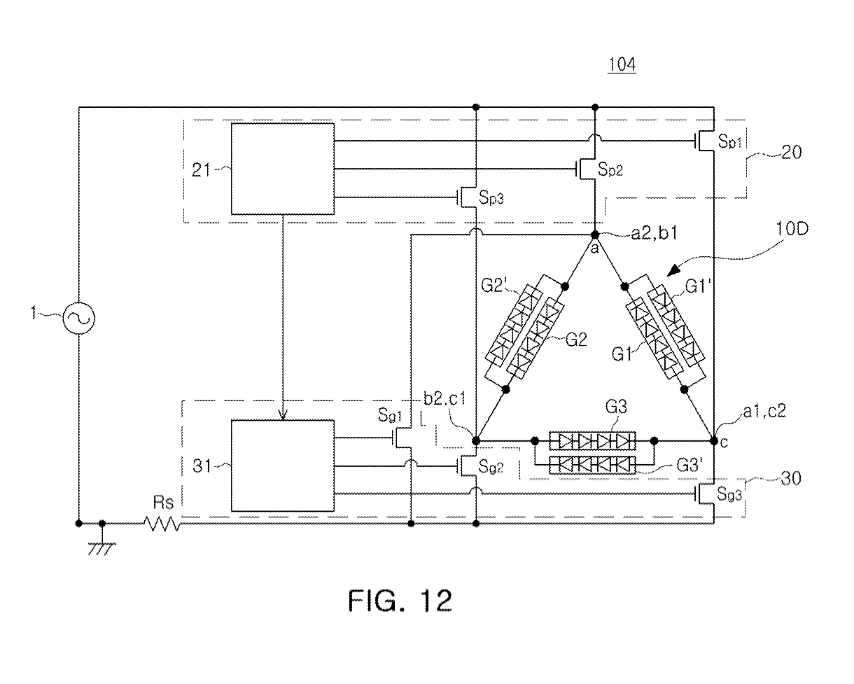

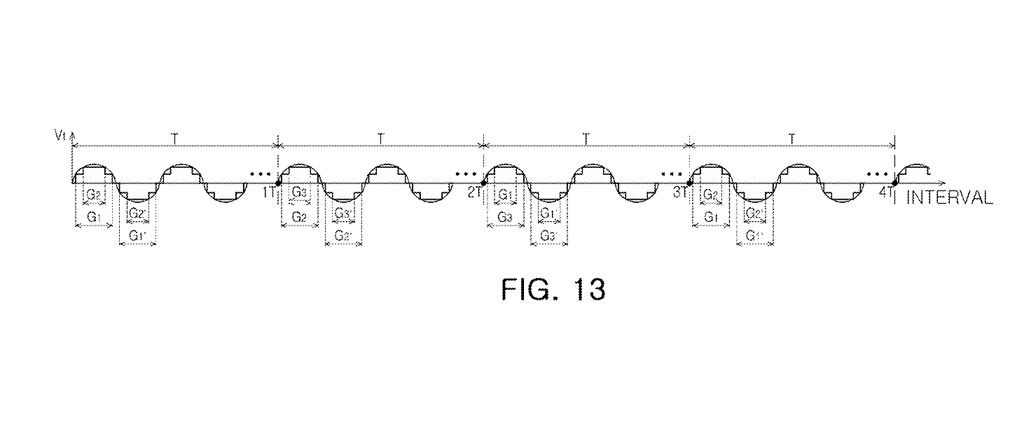

FIG. 12 is a circuit diagram of a light source apparatus 104 including a light source driving apparatus according to an exemplary embodiment. FIG. 13 is a view of a signal waveform illustrating an operation in the circuit diagram of FIG. 12.

With reference to FIG. 12, according to an exemplary embodiment, a light source 10D may include first to n-th sub-light source groups connected to first to n-th light source groups, respectively. The exemplary embodiment of FIG. 12 illustrates that first to third sub-light source groups G1′ to G3′ are provided to correspond to the first to third light source groups G1 to G3.

The respective first to n-th sub-light source groups may include an LED array. The LED array includes at least one LED. The at least one LED is connected in parallel to a different polarity of at least one LED provided in each of the light source groups.

With reference to FIG. 13, operations of a light source apparatus 104 will be described. First to n-th light source groups may be used for the emission of light for a half cycle of alternating current (AC) power, and for the remaining half cycle of the AC power, the first to n-th sub-light source groups may be used for the emission of light. In this case, since the light source apparatus 104 may use the AC power as driving power, the rectifier 40 may not be needed in the light source apparatus 104.

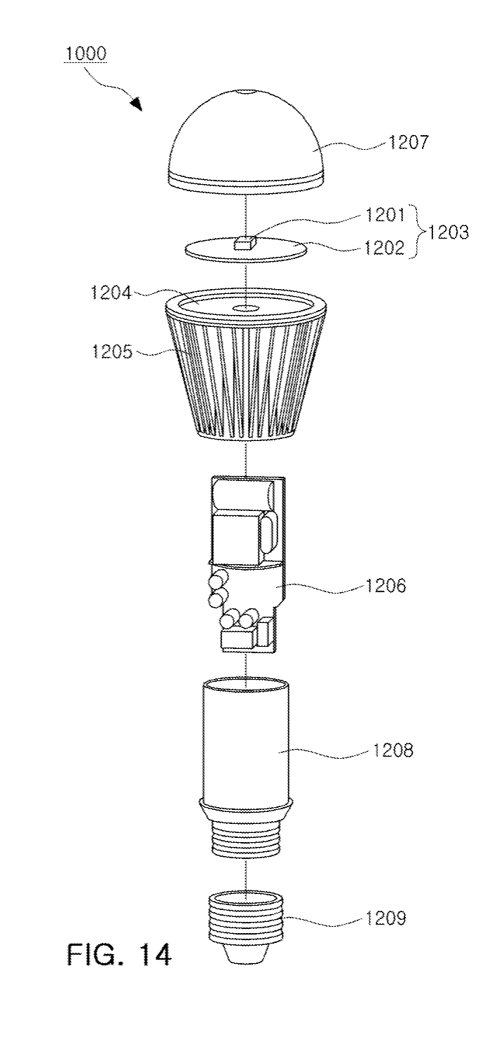

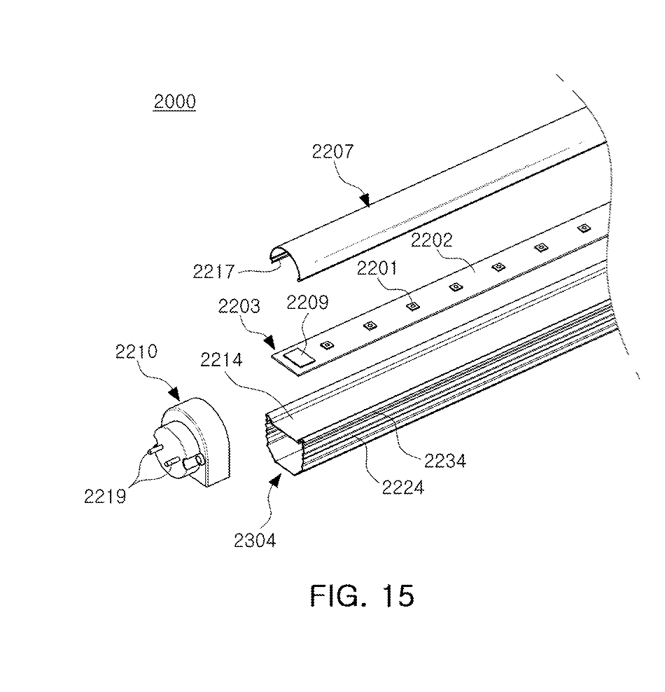

FIGS. 14 and 15 are exploded perspective views of lighting devices employing a lighting source device according to exemplary embodiments.

Here, unless explicitly described otherwise, the terms ‘upper part’, ‘upper surface’, ‘lower part’, ‘lower surface’, ‘side surface’, and the like will be used, based on the drawings, and may be changed depending on a direction in which a lighting device is viewed.

A lighting device 1000 may be a bulb type lamp as illustrated in FIG. 14. The lighting device 1000 may have a shape similar to that of an incandescent lamp, but is not limited thereto, and may emit light having light characteristics similar to those of incandescent lamps, such as a color and a color temperature.

With reference to an exploded perspective view of FIG. 14, the lighting device 1000 may include a light source 1203, a driver 1206, and an external connector 1209. In addition, the lighting device 1000 may further include a structure such as external and internal housings 1205 and 1208 and a cover 1207, which provides an external appearance of the lighting device 1000. The light source 1203 may include an LED 1201 and a circuit board 1202 on which the LED 1201 is disposed. According to an exemplary embodiment, the driver 1206 may include the power path controller and the ground path controller described above according to the foregoing exemplary embodiments, and may also correspond to the light source driving apparatus described above according to the foregoing exemplary embodiments.

In addition, in the lighting device 1000, the light source 1203 may include the external housing 1205 serving as a heat radiator, and the external housing 1205 may include a heat radiating plate 1204 directly contacting the light source 1203 to improve a heat radiation effect. Further, the lighting device 1000 may include the cover 1207 mounted on the light source 1203 and having a convex lens shape. The driver 1206 may be installed in the internal housing 1208 to be connected to the external connector 1209 having a structure such as a socket structure to receive power from an external power supply.

Also, a lighting device implemented by the light source apparatus according to an exemplary embodiment may be a bar-type lamp as illustrated in FIG. 15. A lighting device 2000 may have a shape similar to that of a fluorescent lamp, but is not limited thereto, and may emit light having light characteristics similar to those of fluorescent lamps.

With reference to an exploded perspective view of FIG. 15, the lighting device 2000 according to an exemplary embodiment may include a light source 2203, a body portion 2204, and a driver 2209 and may further include a cover 2207 covering the light source 2203.

The light source 2203 may contain a substrate 2202, and a plurality of LEDs 2201 mounted on the substrate 2202.

The driver 2209 may be disposed on the substrate 2202. The driver 2209 may transfer driving power to the light source 2203. In an exemplary embodiment, the driver 2209 may include the power path controller and the ground path controller as described above according to the foregoing exemplary embodiments, and may also correspond to the light source driving apparatus described above according to the foregoing exemplary embodiments.

The body portion 2204 may allow the light source 2203 to be mounted on a surface thereof to be fixed thereto. The body portion 2204 may be a support structure and may include a heat sink. The body portion 2204 may be formed using a material having excellent thermal conductivity to discharge heat generated by the light source 2203, and for example, may be formed using a metal, but is not limited thereto.

The body portion 2204 may have a form of a lengthwise elongated rod to correspond to the substrate 2202 of the light source 2203. In a surface of the body portion 2204 on which the light source 2203 is mounted, a recess portion 2214 accommodating the light source 2203 therein may be formed.

The body portion 2204 may include a plurality of radiating fins 2224 protruding from at least one side of the body portion 2204 to respectively radiate heat. In at least one outer side of the recess portion 2214, stop grooves 2234 may be extended in a length direction of the body portion 2204. The cover 2207 to be described later may be coupled to the stop grooves 2234.

At least one of both end portions of the body portion 2204 in the length direction thereof may be open, such that the body portion 2204 may have a pipe shaped hollow structure in which at least one end portion is open.

An external connector 2210 may be provided with at least one open end portion of both end portions of the body portion 2204 in the length direction thereof. In an exemplary embodiment, since at least one end portion of the body portion 2204 is open, the external connector 2210 may be provided with at least one end portion of the body portion 2204.

The external connector 2210 may be coupled to at least one or both open end portions of the body portion 2204, respectively, to cover the at least one or both open end portions of the body portion 2204. The external connector 2210 may include an electrode pin 2219 protruding externally therefrom.

The cover 2207 may be coupled to the body portion 2204 to cover the light source 2203. The cover 2207 may be formed using a material allowing for penetration of light therethrough.

The cover 2207 may have a hemispherically curved surface to substantially uniformly irradiate light externally. On a bottom surface of the cover 2207 coupled to the body portion 2204, a protrusion 2217 to be coupled to the stop groove 2234 of the body portion 2204 may be formed in a length direction of the cover 2207.

Although it is described that the cover 2207 has a hemispherical structure, the exemplary embodiments are not limited thereto. For example, the cover 2207 may have a planar quadrangular shaped structure or other polygonal shaped structures. Such a form of the cover 2207 may be variously changed depending on a design of illumination emitting light.

According to an exemplary embodiment, a light source apparatus and a light source driving apparatus in which a circuit configuration may be relatively simplified and the lifespan thereof may be extended are provided.

According to an exemplary embodiment, in the case of a light source apparatus including a plurality of light source groups, the plurality of light source groups may be driven using AC power or rectified AC power having a pulsating current, and the plurality of respective light source groups may be consumed at a comparatively uniform ratio, such that an overall average lifespan of the plurality of light source groups may be extended.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A light source apparatus, comprising:
a light source including a first to an n-th light source groups, n being an integer of two or more, and the first to the n-th light source groups respectively including at least one light emitting diode (LED);
a power path controller connected to first ends of the first to the n-th light source groups and configured to selectively provide a driving power to at least one of the first to the n-th light source groups; and
a ground path controller connected to second ends of the first to the n-th light source groups and configured to control a path of a current flowing through the light source so that a number of light source groups that are driven by the driving power is adjusted based on a level of the driving power,
wherein the first to the n-th light source groups are sequentially connected to one another, and the second end of the n-th light source group is connected to the first end of the first light source group.

2. The light source apparatus of claim 1, wherein the power path controller is configured to selectively provide the driving power to one of the first to the n-th light source groups.

3. The light source apparatus of claim 2, wherein the power path controller is configured to sequentially provide the driving power to the first to the n-th light source groups according to a predetermined interval, and when the driving power is provided to the n-th light source group, the driving power is provided to the first light source group after an elapse of the predetermined interval.

4. The light source apparatus of claim 3, wherein the ground path controller is configured to control the path of the current flowing through the light source such that a number of light source groups that are driven by the driving power is increased in response to an increase in the level of the driving power.

5. The light source apparatus of claim 1, wherein the power path controller comprises:
a first to an n-th power providing switches connected to the first ends of the first to the n-th light source groups, respectively, and configured to selectively provide the driving power to the respectively connected light source groups; and
a power providing switch controller configured to control switching operations of the first to the n-th power providing switches.

6. The light source apparatus of claim 5, wherein the power providing switch controller is configured to turn on a particular power providing switch and turn off remaining power providing switches to selectively provide the driving power to a light source group connected to the particular power providing switch.

7. The light source apparatus of claim 6, wherein the power providing switch controller is configured to sequentially turn on the first to the n-th power providing switches according to a predetermined interval, and turn on the first power providing switch after an elapse of the predetermined interval from the n-th power providing switch being turned on.

8. The light source apparatus of claim 7, wherein the power providing switch controller comprises at least one of a timer and a shift register.

9. The light source apparatus of claim 1, wherein the ground path controller comprises:
a first to an n-th ground path selection switches connected to the second ends of the first to the n-th light source groups respectively, and configured to selectively connect the second ends of the respectively connected light source groups to a ground; and
a ground path switch controller configured to control switching operations of the first to the n-th ground path selection switches.

10. The light source apparatus of claim 9, wherein the ground path switch controller is configured to switch the first to the n-th ground path selection switches such that the number of the light source groups that are driven by the driving power is increased in response to an increase in the level of the driving power.

11. The light source apparatus of claim 1, wherein the light source comprises:
a current path interruption portion connected between two light source groups, among the first to the n-th light source groups, and configured to block a current path between the two light source groups; and
a bypass switch connected in parallel to the current path interruption portion and configured to selectively provide a current path between the two light source group.

12. The light source apparatus of claim 1, further comprising a brightness detector configured to detect external brightness,
wherein the ground path controller is configured to control a path of a current flowing from a light source group that receives the driving power, among the first to the n-th light source groups, to a ground, so that a maximum number of the light source groups that are driven by the driving power is reduced when a degree of the detected brightness is higher than a reference value.

13. The light source apparatus of claim 1, further comprising a rectifier configured to rectify alternating current (AC) power and provide a rectified driving power to the power path controller.

14. The light source apparatus of claim 1, wherein the light source further comprises a first to an n-th sub-light source groups connected in parallel to the first to the n-th light source groups, respectively, a sub-light source group including at least one LED having a first polarity, which is connected to a second polarity of at least one LED that is provide in a light source group connected in parallel to the sub-light source group.

15. A light source driving apparatus for controlling an operation of a light source including a first to an n-th light source groups having at least one light emitting diode (LED), n being an integer of two or more, the first to the n-th light source groups being sequentially connected one another, and a first end of the first light source group being connected to a second end of the n-th light source group, the light source driving apparatus comprising:
a power path controller configured to provide driving power to the light source; and
a ground path controller configured to control a path of a current flowing through the light source to a ground,
wherein the power path controller is connected to first ends of the first to the n-th light source groups, and is configured to selectively provide the driving power to at least one of the first to the n-th light source groups, and
the ground path controller is connected to second ends of the first to the n-th light source groups, and is configured to adjust a number of light source groups that are driven according to a level of the driving power.

16. A method of driving a light source comprising a plurality of light source groups, the method comprising:
sequentially providing a driving power to the plurality of light source groups according to a predetermined time interval, the plurality of light source groups being connected to one another; and
controlling a current path of the light source such that a number of a light source group that is driven by the driving power among the plurality of light source groups is adjusted based on a level of the driving power.

17. The method of claim 16, wherein the plurality of light source groups respectively include at least one light emitting diode (LED), and each of first ends of the light source groups is connected to a second end of an adjacent light source group.

18. The method of claim 17, wherein the sequentially providing comprises:
connecting a plurality of power providing switches between a power source and the first ends of the plurality of light source groups, respectively; and
controlling switching operations of the plurality of providing switches to sequentially provide the driving power from the power source to each of the plurality of light source groups according to the predetermined time interval.

19. The method of claim 17, wherein the controlling comprises:
connecting a plurality of ground path selection switches between a ground and second ends of the plurality of light source groups, respectively; and
controlling switching operations of the plurality of ground path selection switches to selectively connect a light source group to a ground.

20. The method of claim 16, wherein the level of the driving power changes over time, and the current path of the light source is controlled such that respective time intervals in which the plurality of light source groups are driven by the driving power during a predetermined period of time are substantially the same.
